(19) United States
(12) Patent Application Publication
(10) Pub. No.: US 2005/0289356 A1
(43) Pub. Date: Dec. 29, 2005

(54) Process for automated and self-service reconciliation of different loging IDs between networked computer systems

(76) Inventor: Idan Shoham, Calgary (CA)

Correspondence Address: Idan Shoham, 500, 1401 1st Street SE, Calgary, AB, T2G 2J3, CA

(21) Appl. No.: 10/878,944

(22) Filed: Jun. 29, 2004

(51) Int. Cl. G06F 15/16; H04K 1/00; G06F 17/30; H04L 9/00; G06F 7/04; G06F 7/58; G06K 19/00; G06K 9/00; H04L 9/32

(52) U.S. Cl. 713/183; 726/4

(57) ABSTRACT

A method for building a set of data that reconciles user login IDs between multiple, networked computer systems is disclosed. The method comprises the steps of: 1. Periodically constructing an inventory of login IDs by extracting this data from the internal security systems of a number of networked computer systems. 2. Constructing a list of users by merging login IDs from one or more systems of record. 3. Checking the registration status of each user. 4. Sending electronic notification to unregistered users asking them to register. 5. Authenticating users when they sign in by accepting their login ID and password to some system of record, and asking that system to check those values. 6. Requesting the users to enter additional ID/password credentials. 7. Checking the login ID inventory for occurrences of the ID typed by the user. 8. Requesting each system identified from the inventory as containing the ID typed by the user to validate the ID and password typed by the user. 9. On successful credential validation, attaching one or more login ID/system ID pairs to the user's profile. 10. Iterating through the process until the user has entered all of his/her login IDs across a set of managed systems. The present invention provides a method for quickly and inexpensively assembling data that connects multiple login IDs on different systems to one another, to create profiles that represent every login ID of each user in an organization. This data is valuable for a variety of applications in user identity management.

### CROSS-REFERENCE TO RELATED APPLICATIONS

Not Applicable

### FEDERALLY SPONSERED RESEARCH

Not Applicable

### SEQUENCE LISTING OR PROGRAM

Not Applicable

### BACKGROUND OF THE INVENTION—FIELD OF INVENTION

The present invention relates in general to a method for reconciling, or establishing a relationship of ownership, between multiple login IDs, used to sign into multiple networked computer systems, and their human owners.

### BACKGROUND OF THE INVENTION

This data is useful for a variety of applications, including password synchronization, self-service and assisted password reset, access termination, account administration and others.

The data described in [1] is essential for a wide variety of applications, including those mentioned in [2]. Accordingly, numerous strategies have been attempted in the past to produce this correlation data.

One strategy for correlating login IDs is to match user profiles on two or more systems by correlating some key attribute, that appears in the profile of each user on each system, and which is expected to be the same on each system. For example, each system's user profile database may contain an entry for an employee number, which is expected to be consistent between systems, and globally unique.

The strategy described in [4] is only effective if there is such an attribute, and if it has been entered reliably and fully into the profile of each user on each system.

In cases where the strategy described in [4] is inadequate, due to problems with the availability or quality of connecting attribute data, some efforts have been made to correlate users with multiple attributes, or an approximate match on attributes that are expected to have errors, such as full user names.

The strategy described in [6] is of limited value in large organizations:
1. Where one attribute is not available to correlate login IDs, it is unlikely that multiple attributes will be available.
2. Approximate matches on attributes will yield incomplete results and erroneous results, which require manual cleanup. In many applications, errors in the correlation data set result in security vulnerabilities. For example, one user may be able to take advantage of an error in the data set, plus a self-service password reset application, to set another user's password, and subsequently compromise the other user's electronic access to systems and data.

Overall, prior strategies for creating the login ID correlation data described herein have, in cases where organizations have inconsistent login IDs on different systems, been slow, expensive and error prone.

### SUMMARY

The data described in [1] is essential for a wide variety of applications, including those mentioned in [2]. Accordingly, numerous strategies have been attempted in the past to produce this correlation data.

Preceding strategies for generating login ID reconciliation data have not worked well, as described in [10]. This approach, which combines automated discovery of users, automatic reminders sent to users asking for their input, and validated user input of login ID/password credentials generates complete and reliable login ID reconciliation and resolves the problems experienced by previous strategies. Namely:
1. The data collected is validated, and so contains no errors.
2. Data is entered by numerous users concurrently, therefore the total time required to produce the correlation data is minimal.
3. No one person enters the data or manages the user prompting process, so there is no labor cost to produce the data.

### DRAWINGS—FIGURES

FIG. 1 is a schematic illustrating the networked systems that interact in the login ID reconciliation process. Arrows indicate communication between systems, and the direction of each arrow indicates which system initiated the communication.

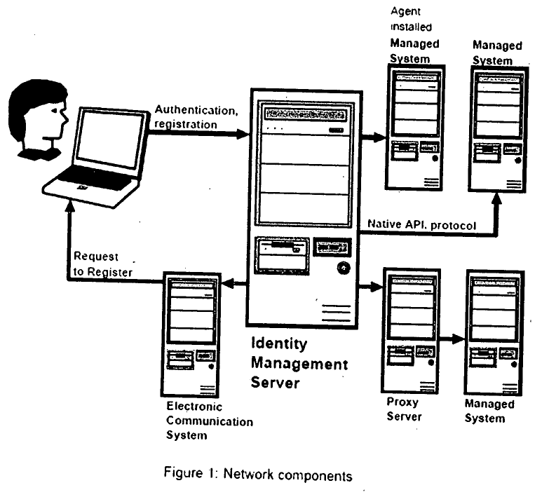

In FIG. 1, one or more systems are tasked to perform the described process. These systems are collectively labeled Identity Management Server.

In FIG. 1, the identity management server periodically collects a list of login IDs from any number of managed systems using one of four mechanisms:
1. Using a managed system's native application programming interface (API), which operates over a network.
2. By communicating with an agent installed on the managed system, and asking that agent to fetch the information using some facility available locally on that managed system.
3. Using either of the two methods described above, but indirectly, by asking a proxy server to ask the managed system for the data.
4. (not shown) By having a process execute on the managed system, and send the data through a file transfer mechanism to the identity management server. [23] The first three methods are also used to validate login ID/password pairs that a user types into to registration user interface on the identity management server. [24] The identity management server sends requests to register and subsequent reminders to users through an electronic communication system. This is typically e-mail, but may involve other forms of communication (instant messaging, SMS messaging, Windows popup messages and others).

Users register by accessing a user interface exposed by the identity management server, and keying in both initial authentication and additional login ID/password pairs. This user interface may take multiple forms, including a web form, a Windows GUI program, e-mail interaction and others.

### DETAILED DESCRIPTION—FIG. 1-NETWORK COMPONENTS

Definition: Managed System

A managed system may be a computer operating system, database or application where users access some features or data, and where user access must be controlled.

Definition: Target System

Please see [27].

Definition: Platform

A type of managed system. There are many possible types of platforms, including:
Network operating systems: Windows NT, Windows 2000, Novell NetWare, etc.
Directories: LDAP, x.500, etc.
Host operating systems: MVS/OS390/zOS, OS400, OpenVMS, Tandem, Unisys, etc.
Groupware and e-mail systems: MS Exchange, Lotus Notes, Novell GroupWise, etc.
Applications: SAP R/3, PeopleSoft, Oracle Applications, etc.
Database servers: Oracle, Sybase, MSSQL, Informix, DB2/UDB, etc.

Definition: User

Users are people whose access to systems and identity information must be managed.

Definition: Authentication

Authentication is a process used by a system to uniquely identify a user. Most systems authenticate users by requesting them to type a secret password. Other forms of authentication include:
Using hardware tokens.
Using a PKI certificate.
Using a smart card.
Providing a biometric sample (finger print, voice print, etc.)
Answering personal questions.

Definition: Account

An account is the data used by a system to identify a single user, authenticate a user and control that user's access to resources.

Definition: Login ID

On most systems, accounts are uniquely identified by a short string of characters. This is called the Login ID, user ID or login name.

Definition: Standard Login ID

In some environments a user may have a standard login ID, which is expected to be the same on every system.

Definition: Global Login ID

A global login ID is an identifier, which uniquely identifies a user in an organization. It may or may not be used as the Login ID on any one system, but is guaranteed to be unique (i.e., no two users may share the same Global login ID).

Definition: Alias

A user is said to have an alias on a particular system in case there is some notion of a global or standard login ID, but on the system in question the user signs on with a non-standard ID. The alias is that non-standard ID.

An alias may also be referred to as an alternate login ID, or a non-standard login ID.

Definition: Credentials

A user's credentials to a system consist of a unique login ID and an authenticator. In most cases, the authenticator is a password.

Definition: Password Synchronization

A password synchronization system is any software or process used to help users maintain a single password value on multiple password-protected systems.

Password synchronization may be optional or mandatory. Users may be encouraged to synchronize their passwords manually, or provided with an automated system for updating multiple passwords simultaneously.

Definition: Self-Service

Self-service is any process that allows a user to access a system function that would otherwise only be available to a system administrator or help desk analyst.

Definition: Password Reset

A password reset is some process where a user who has either forgotten his own password, or triggered an intruder lockout on his own account can authenticate with something other than his password, and have a new password administratively set on his account.

Password resets may be performed by a help desk, or by self-service automation.

Definition: Assisted Password Reset

An assisted password reset is a password reset ([66]) accomplished by interaction between the user and a support analyst, typically over a telephone.

Assisted password resets are similar to self-service password resets ([72]), but with the intervention of a support analyst.

Definition: Self-Service Password Reset

A self-service password reset is a password reset ([66]) accomplished by interaction between the user and automated software (a web site, IVR system or other facility).

Self-service password resets are similar to assisted password resets ([69]), but without intervention of a support analyst.

Definition: Agent

An agent is a software component that allows an access management system to create, update or delete accounts on a managed system, or that allows an authentication management system to set or validate passwords or other authenticators on a managed system.

Agents may be installed on the access management or authentication management server itself, on the managed system, or on an intermediate (proxy) server.

Agents installed on the identity management server are sometimes called remote agents, because they use a remote administration software protocol understood by the managed system. Conversely, agents installed on the managed system are sometimes called local agents.

Definition: Connector

Connector is another term for agent—see [75].

Definition: Identity Management Server

Identity management systems normally run on their own hardware, on a dedicated server. This is the identity management server.

Examples are servers used to provide self-service password reset, password synchronization, and central user administration, to manage access change authorization workflow, etc.

Definition: Login ID Reconciliation

Users may have different Login IDs on different systems (aliases). Any system intended to manage user access or authentication across multiple systems must begin by constructing profiles for each user, which attach Login IDs on each system where that user has an account to that user.

The process of constructing these user profiles is called Login ID reconciliation.

The invention described here is a process to carry out login ID reconciliation. It produces a set of data that connects login IDs on a set of managed systems to individual users, such that each user has one or more login ID, which may be the same or different, and are associated with one or more managed systems, in his profile.

The process is implemented by a computer program performing the following steps:
1. Periodically constructing an inventory of login IDs by extracting this data from the internal security systems of a number of networked computer systems.
2. Constructing a list of users by merging login IDs from one or more systems of record.
3. Checking the registration status of each user.
4. Sending electronic notification to unregistered users asking them to register.
5. Authenticating users when they sign in by accepting their login ID and password to some system of record, and requesting that system to check those values.
6. Asking users to enter additional ID/password credentials.
7. Checking the login ID inventory for occurrences of the ID typed by the user.
8. Requesting each system identified from the inventory as containing the ID typed by the user to validate the ID and password typed by the user.
9. On successful credential validation, attaching one or more login ID/system ID pairs to the user's profile.
10. Iterating through the process until the user has entered all of his/her login IDs across a set of managed systems.

This process has several advantages over other strategies that have been used in the past to generate the same data set:
1. This process does not produce errors. Login IDs are only attached to user profiles after password validation, which ensures that the user who claimed the login ID really does have access to the account in question.
2. The process is inexpensive. No central or manual effort is required to collect or correlate login IDs.
3. The process is rapid. Simultaneous input from large numbers of users produces the desired data set very quickly.
4. There are no difficult-to-meet pre-requisites. There is no need for user attributes on managed systems to exist, be complete, or be correct.

1. A method for building a set of data that reconciles user login IDs between multiple, networked computer systems, comprising the steps of:
(a) Periodically constructing an inventory of login IDs by extracting this data from the internal security systems of a number of networked computer systems.
(b) Constructing a list of users by merging login IDs from one or more systems of record.
(c) Checking the registration status of each user.
(d) Sending electronic notification to unregistered users asking them to register.
(e) Authenticating users when they sign in by accepting their login ID and password to some system of record, and requesting that system to check those values.
(f) Asking users to enter additional ID/password credentials.
(g) Checking the login ID inventory for occurrences of the ID typed by the user.
(h) Asking each system identified from the inventory as containing the ID typed by the user to validate the ID and password typed by the user.
(i) On successful credential validation, attaching one or more login ID/system ID pairs to the user's profile.
(j) Iterating through the process until the user has entered all of his/her login IDs across a set of managed systems.

2. The method as set forth in claim 1, wherein at step 1a the inventory of login IDs extracted from each system is in the form of a list, where each list entry consists of a unique system identifier plus a user identifier unique within that system.

3. The method as set forth in claim 1, wherein at step 1a a variety of means may be used to extract the login ID inventory from each system, including:
(a) Use of an application programming interface (API) native to that system,
(b) Installation of a specially constructed agent directly on that system,
(c) Communication between the system executing the process described herein (hereinafter referred to as the identity management server), and the managed system, using an intermediate or proxy server.
(d) Execution of some software or script directly on the managed system, with the resulting list placed in a file, and transferred to the identity management server.

4. The method as set forth in claim 1, wherein at step 1b each user profile is represented as a globally unique user identifier, combined with a list of attributes and a list of system identifier/login identifier pairs.

5. The method as set forth in claim 1, wherein at step 1c the registration status of any given user may be determined by a variety of means, including:
(a) Checking whether the user had previously successfully registered any information.
(b) Checking whether the user profile contains some minimum number of system ID/login ID pairs.
(c) Checking whether the user profile contains system ID/login ID entries for systems that are deemed mandatory.

6. The method as set forth in claim 1, wherein at step 1d notification sent to the user that registration is requested may take the form of any electronic communication, including electronic mail.

7. The method as set forth in claim 1, wherein at step 1d notification sent to the user include a reference or link to the program the user must access to proceed to step 1e. This reference may take many forms, including that of an embedded uniform resource locator (URL).

8. The method as set forth in claim 1, wherein at step 1d the frequency with which any given user is reminded to register can be limited, so that the process does not become a nuisance to users.

9. The method as set forth in claim 1, wherein at step 1d the total number of requests to register sent to users per iteration of the process is limited, so that the process does not become an undue burden to the electronic communication infrastructure.

10. The method as set forth in claim 1, wherein at step 1f the user may or may not explicitly specify the system for which the login ID and password that he typed apply.

11. The method as set forth in claim 1, wherein at step 1g login IDs which appear in the inventory but have already been assigned to some user's profile may optionally be removed from consideration at step 1h, in order to expedite the process.

12. The method as set forth in claim 1, wherein at step 1i the user profile may be stored internally to the identity management server, or in an external database or directory, or both.
Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.
